(19) United States
(12) Patent Application Publication
(10) Pub. No.: US 2026/0036169 A1
(43) Pub. Date: Feb. 5, 2026

(54) SPHERICAL ROLLER BEARING HAVING SEPARATE CAGES

(71) Applicant: AKTIEBOLAGET SKF, GOTEBORG (SE)

(72) Inventors: Stefan Manfred WEIGAND, Rannungen (DE); Sabine HOFMANN, Kürnach (DE); Johan SAHLGREN, Mölndal (SE)

(21) Appl. No.: 19/278,807

(22) Filed: Jul. 24, 2025

(30) Foreign Application Priority Data
Jul. 30, 2024 (DE) 102024207177.3

(51) Int. Cl. F16C 33/58; F16C 33/34; F16C 33/38

(52) U.S. Cl. CPC F16C 33/583; F16C 33/34; F16C 33/3806; F16C 2360/31

(57) ABSTRACT

A spherical roller bearing for supporting a wind turbine main shaft includes an outer ring, an inner ring having a diameter of at least 499 mm, two sets of spherical rollers which roll along raceways formed on the outer and inner rings, and first and second cages each configured to retain a separate one of the sets of spherical rollers. Each one of the first and second cages includes a first cage ring extending in a circumferential direction of the spherical roller bearing, a second cage ring spaced axially from the first cage ring and connected to the first cage ring by a plurality of cage bars so as to form closed pockets. Each pocket receives a separate one of the spherical rollers of one of the two sets of spherical rollers.

### CROSS-REFERENCE

This application claims priority to German patent application no. 102024207177.3 filed on Jul. 30, 2024, the contents of which are fully incorporated herein by reference.

### BACKGROUND OF THE INVENTION

The present invention relates to bearings, and more particularly to a spherical roller bearing.

Rolling bearings are common mechanical components for many different applications. There are different types of rolling bearings that are designed to meet different requirements. Depending on the conditions of the particular application, i.e., the load level, the rotational speed, the temperature, etc., there are different types of suitable rolling bearings.

A common type of bearing is a spherical roller bearing. Such bearings are designed to accommodate large radial loads and axial loads, and are also designed to accommodate flexing of a shaft supported by the bearings, i.e., the bearing rings can be relatively misaligned. Therefore, such bearings are particularly suitable for more demanding industrial applications such as machines in wind turbines and the like.

In the most demanding industrial applications for spherical roller bearings, a majority of bearing failures are related to increased surface-initiated fatigue. One reason that increased surface-initiated fatigue occurs may be caused by an insufficient lubrication of the bearing. Usually, spherical roller bearings are relubricated in operation. A spherical roller bearing may generally comprise two sets of rollers and the relubrication may be done at a special bore in the outer ring located between both sets of rollers to simultaneously lubricate both sets of rollers. Also, by adding fresh lubricant, it may be possible to flush any particles from the bearing that could otherwise increase the risk for surface-initiated fatigue. However, in most spherical roller bearings, the spherical rollers are retained in a cage which usually has a central ring element, and this ring element may act as an obstacle for the added lubricant.

It is therefore object of the present invention to improve a relubrication of a spherical roller bearing.

### SUMMARY OF THE INVENTION

The object of the present invention is solved by a spherical roller bearing used for supporting a wind turbine main shaft and comprising at least an outer ring, an inner ring and two set of spherical rollers which roll along raceways formed on each one of the outer and inner rings. The inner ring has a bore with a diameter of at least 499 mm, preferably at least 699 mm, and most preferably at least 899 mm. The bore may be adapted to receive a component of another machine, for example a shaft of a wind turbine.

The inner ring may be formed with or without flanges on an axial inner side and/or an axial outer side. If the inner ring is equipped with flanges, flanges may be used as guide flanges for the roller elements. Furthermore, the flanges may also serve as retaining flanges for preventing the rollers from falling out of the bearings.

In order to improve the relubrication of the spherical roller bearing, the spherical roller bearing comprises a first and second cage each configured to retain one set of rollers, wherein each of the first and second cage comprises first cage ring extending in a circumferential direction of the spherical roller bearing, a second cage ring spaced from the first cage ring on an axial side and connected to the first cage ring by a plurality of cage bars, thereby forming closed pockets, each pocket being configured to receive one spherical roller of the one set of rollers.

The first cage and the second cage may be separate from each other.

Two separate cages may enable one set of rollers to have a different rotational speed than the other row of rollers. This may reduce the forces that act on each cage compared to a single cage which couples the two set of rollers. Alternatively, the first and second cages may be separate from each other, but arranged so close to each other that it may be possible for the first and second cages to support each other while still be able to have a relative movement.

According to a further embodiment, the first cage and/or the second cage may be made from sheet metal.

Using sheet metal as the base material for the first cage and/or the second cage may have the advantage of reducing the costs for the first cage and/or the second cage.

Alternatively, either or both cages may be made from a cast material or machined from a solid material.

According to a further embodiment, the pockets may be formed by pressing and coining and/or milling.

According to a further embodiment, the cage bars may be at least partially arranged at a position in a radial direction that is at least partially offset to a pitch diameter.

As used herein, the term “pitch diameter” means a diameter on which the center points of the spherical rollers will run during operation.

For example, the cage bars may be at least partially arranged at a distance from the raceway of the inner or outer ring in the radial direction that corresponds to 10% to 40% of a diameter of a spherical roller, or 60% to 90% of the diameter of the spherical roller, respectively.

Furthermore, at least one cage bar may be arranged such that more than half of a cage bar length in the axial direction or even the entire axial cage bar length is arranged offset to the pitch diameter. For example, the at least one cage bar may be arranged such that more than half of its axial length, or even its entire axial length, is in a radially inner side or a radially outer side of the pitch diameter. Moreover, a plurality of the cage bars or even all cage bars may be arranged such that more than half of their axial length or even their entire axial length are located in a radially inner side or a radially outer side of the pitch diameter.

Arranging the cage bars at a position in a radial direction that is offset to a pitch diameter may allow a decrease in a distance between two neighboring rollers such that it may be possible to increase the number of rollers in a set of rollers. In addition, arranging the cage bars at a position in a radial direction that is at least partially offset to a pitch diameter may enable an increase in a width of the cage bar even with very small nominal roller distances. More particularly, increasing the number of rollers in the set of rollers may have the advantage that the basic dynamic load rating of the spherical roller bearing can be increased without the necessity of adapting the outer ring and/or inner ring of the bearing.

According to a further embodiment, the inner ring is formed without any flange configured to retain and/or guide the spherical rollers.

Providing the first cage and the second cage with closed pockets for the rollers may have the advantage of stopping an axial movement of the roller. This enables omitting any guiding and/or retaining flanges on the inner ring. Furthermore, the manufacturing time may be reduced since the machining of the flanges is not needed. Also, the stresses in the inner ring may be reduced as no undercut has to be formed in the inner ring to form the retaining flange. Thus, the costs and/or the needed amount of raw material for the inner ring can be reduced.

According to a further embodiment, the spherical roller bearing is not equipped with a guide ring.

A guide ring or mid rip flange is typically used to limit a roller skew in an unloaded zone of the spherical roller bearing such that the rollers enter the loaded zone of the spherical roller bearing with a limited skew. This is particularly necessary in a high-speed application. Wind main shaft applications are usually low speed applications with a rotational speed of 15 RPM or lower. This enables omission of a guide ring.

According to a further embodiment, the at least one cage may be free of any means for retaining at least one spherical roller in the at least one cage and/or in a pocket of the at least one cage.

In particular, the at least one cage and/or parts of the cage, such as the first cage ring, the second cage ring, the cage bars, or the like, may be free of any means for holding or retaining the spherical rollers such that they cannot be lost. In other words, the at least one cage may comprise neither means for snapping the spherical rollers into the at least one cage nor dimples formed on the axial end faces of the pockets for engaging with recesses formed on end faces of the spherical rollers. Due to the lack of retaining means, the manufacturing costs for the at least one cage may be reduced. Also, since the at least one cage may be free of any means for retaining at least one spherical roller in the cage it may be possible to exchange individual spherical rollers, for example during maintenance.

According to a further embodiment, the at least one cage and/or the spherical rollers may be mountable into the spherical roller bearing without elastically and/or plastically deforming the at least one cage and/or without disassembling the at least one cage. In particular, the term “deforming the at least one cage and/or disassembling the at least one cage” may refer to a procedure of bending, twisting, distorting, cutting, or otherwise dismantling the at least one cage in order to mount the at least one cage and/or any of the spherical rollers into the spherical roller bearing.

According to a further embodiment, a ratio Dm/Dw of a minimal distance Dm in the circumferential direction between the raceways of two neighboring spherical rollers of at least one set of spherical rollers to a maximal roller diameter Dw is equal to or below 0.11, preferably 0.09, and most preferably no more than 0.075, when the spherical rollers of the at least one set of spherical rollers are equally spaced in the circumferential direction.

Reducing a distance between two adjacent rollers in the circumferential direction enables an increase in the number of rollers in the set of rollers. For example, it may be possible to increase the number of rollers in the set of rollers by at least one. This may enable an increase in the basic dynamic load rating of the spherical roller bearing. Moreover, increasing the number of rollers in the set of rollers by at least one may have the advantage of significantly increasing a service life of the spherical roller bearing. Furthermore, the ratio Dm/Dw of the minimal distance Dm in the circumferential direction between the raceways of two neighboring spherical rollers of the first set of rollers to the maximal roller diameter Dw, when the spherical rollers of the first set of rollers are equally spaced in the circumferential direction, may be equal to or different than the ratio Dm/Dw of the minimal distance Dm in the circumferential direction between the raceways of two neighboring spherical rollers of the second set of rollers to the maximal roller diameter Dw, when the spherical rollers of the second set of rollers are equally spaced in the circumferential direction.

When the spherical rollers of at least one set of the spherical rollers are equally spaced in the circumferential direction, a minimal distance Dm in the circumferential direction between the raceways of two neighboring spherical rollers of the at least one set of spherical rollers may be equal to or below a value obtained by the following equation:

$$Dm \leq 0.0064 mm \cdot {( ln ( P \cdot Dw + Dw ) )}^{3}$$

wherein P is the pitch diameter and Dw is the maximal roller diameter, wherein the millimeter values of P and Dw are to be used as dimensionless variables. Moreover, the minimal distance Dm in the circumferential direction between the raceways of two neighboring spherical rollers of the first set of rollers, when the spherical rollers of the first set of rollers are equally spaced in the circumferential direction, may be equal to or different than the minimal distance Dm in the circumferential direction between the raceways of two neighboring spherical rollers of the second set of rollers, when the spherical rollers of the second set of rollers are equally spaced in the circumferential direction.

According to a further embodiment, each set of spherical rollers may comprise the same number of spherical rollers. Preferably, each set of spherical rollers may comprise the maximal number of spherical rollers (i.e., that may fit within the raceways).

Fitting the spherical roller bearing with the maximal number of spherical rollers, may enable an increase in the basic dynamic load rating of the spherical roller bearing.

According to a further embodiment, the first cage ring of each cage is arranged on an axially inner side of the spherical roller bearing such that a gap is formed at least partially between the first cage ring of the first cage and the first cage ring of the second cage.

Advantageously, the first cage rings of the first and second cage may act like a funnel that transports a lubricant to the inner ring of the spherical roller bearing.

Preferably, a size of the gap in the axial direction may be at least 0.5 mm, preferably at least 1 mm. In particular, the size of the gap may be determined in a condition in which the spherical rollers, the first cage and the second cage of the spherical roller bearing are at a nominal position. More specifically, a nominal roller position may be a position in which a contact angle of the spherical bearing is met, and a nominal cage position may be a position in which a rotation axis of the first and second cage axis is coincident with the rotation axis of the inner ring, and an axial clearance of the cage pockets is equally divided such that there is the same clearance between the roller side face and cage pocket side face at both the axial inner side face and the axial outer side face of each cage.

According to a further embodiment, the first cage ring and/or at least one of the second cage rings includes a flange element that extends radially inwardly or radially outwardly.

Having a flange element that extends radially inwardly or radially outwardly may limit cage deformations when strong forces act on the first and/or second cage causing the cage to deform.

According to a further embodiment, the first cage ring and at least one of the second cage rings includes a radially extending flange element, wherein both flange elements extend radially inwardly or radially outwardly.

Having both cage rings equipped with a radially extending flange element may lead to an additional increase of a stiffness of the cage. This results in the benefits of a lower deformation of the cage and a better cage performance.

According to a further embodiment, the first cage ring and at least one of the second cage rings may include a radially extending flange element, wherein one flange element extends radially inwardly, and the other flange element extends radially outwardly.

Having one flange element extending radially inwardly and the other flange element extending radially outwardly may lead to a significant increase in stiffness. This enables an even further decrease in the deformation of the cage and may allow for a better cage performance.

According to a further embodiment, a free end of the flange element of the first cage rings is inclined in direction toward the spherical roller. Preferably, the free ends of flange element of the first cage rings may have an opening angle in the range between 2° and 40°. This may have the advantage that a lubricant flow towards the inner ring may be further improved.

According to a further embodiment, a shoulder clearance is larger than a radial cage clearance.

In particular, the shoulder clearance may be defined as the difference of a bore diameter of the cage ring and a diameter of the inner ring at a position of the cage ring. By designing the cage such that the shoulder clearance is larger than the radial cage clearance, it is possible to make the cage is roller guided.

For example, the shoulder clearance may be designed such that it is between 1 mm and 15 mm larger than the radial cage clearance, if the cage bore diameter up to 1200 mm. In case the cage bore diameter is larger than 1200 mm, the shoulder clearance may be designed such that it is between 1 mm and 20 mm larger than the radial cage clearance.

Moreover, the radial cage clearance may be in the range of 0.2 mm to 5 mm, preferably between 0.5 mm to 3 mm. The radial cage clearance may be measured by the maximal radial movement of the first cage and/or the second cage inside the bearing.

According to a further embodiment, the first cage and/or the second cage is predominantly roller guided.

The term “predominantly roller guided” refers to a case in which the cage is usually roller guided, but in cases in which the cage is deformed, for example due to high forces acting on the cage, the deformation may be limited by the cage bore. This may limit the extreme loads on the cage. This guiding principle may also be called “mixed guidance”. Alternatively, the first cage and/or the second cage may be just roller guided. In other words, even if the cage deforms, the cage is designed in such a way that no contact between the cage rings and the inner or outer ring occurs. Roller guided and/or predominantly roller guided cages may have the advantage that they may experience less wear compared to shoulder guided cages. This may result in less particles in the bearing, which can lead to an increased service life.

In another alternative design, the first and/or second cage may be predominantly shoulder guided at the cage bore and/or supported on a mid-rib or guiding flange of the inner ring.

According to a further embodiment, each pocket of the first cage and/or the second cage is adapted to limit a skew of the spherical roller accommodated in the pocket.

Limiting the skew of the spherical roller in the pocket may reduce a contact force generated by the roller contacting the cage. This may further lead to a reduced wear on the first cage and/or the second cage.

For example, the skew of the roller in the pocket may be limited by a radial cage clearance. In addition or alternatively, the roller skew may be limited by an axial cage pocket clearance. In particular, the axial cage pocket clearance may be between 0.2 mm and 2.5 mm, preferably between 0.5 mm and 2 mm, and mostly preferably between 0.7 mm and 1.5 mm.

According to a further embodiment, each cage bar may be provided with a contact surface configured to contact the spherical roller, wherein the contact surface may be positioned at a circumferential side face of each cage bar.

Furthermore, the contact surface may be provided with a radius. This allows that if the roller is skewed and/or moves in the axial direction, the contact between the roller and the contact surface may be still tangential with reduced contact loads. This may result in a decreased risk of wear.

According to a further embodiment, a circumferential side face of each cage bar may be provided in the axial direction with one contact area.

For example, the circumferential side face of each cage bar may be provided with an osculation between the cage bar and the roller. The osculation, which is the radius on cage bar divided by a crowning radius of the roller, may be between 100% and 104%. This may lead to a reduction of the contact stresses compared to a straight cage bar.

According to a further embodiment, a circumferential side face of each cage bar may be provided in the axial direction with at least two contact areas configured to contact the roller.

Preferably, the contact areas may be located adjacent to the side faces of the roller. Having at least two contact areas may reduce roller skew. Furthermore, at least two contact areas may have the advantage that stress on the first cage and/or the second cage may be reduced. In particular, when a point of contact between the roller and the cage bar is as close as possible to the cage rings, a bending moment of the cage bar may be reduced, resulting in reduced stress within the first and/or second cage.

According to a further aspect, a bearing arrangement for a wind turbine main shaft is provided, wherein the bearing arrangement includes at least one spherical roller bearing as described above.

All features described above with respect to the spherical roller bearing apply, separately or in combination, to the spherical roller bearing used in the bearing arrangement.

Further preferred embodiments are defined in the dependent claims as well as in the description and the figures. Thereby, elements described or shown in combination with other elements may be present alone or in combination with other elements without departing from the scope of protection of the present invention.

### BRIEF DESCRIPTION OF THE SEVERAL VIEWS OF THE DRAWINGS

In the following, preferred embodiments of the invention are described in relation to the drawings, wherein the drawings are exemplary only, and are not intended to limit the scope of protection. The scope of protection is defined by the accompanied claims, only. The figures show:

FIG. 1 is a schematic cross section of a spherical roller bearing according a first embodiment;

FIG. 2 is a schematic cross section of a spherical roller at a maximal diameter of the spherical roller in a cage of the spherical roller bearing according to the first embodiment;

FIG. 3 is a schematic perspective view of a first cage of the spherical roller bearing according to the first embodiment;

FIG. 4 is a section of a side view of the spherical roller bearing according to the first embodiment; and

FIG. 5 is a schematic cross section of a cage of a spherical roller bearing according to a second embodiment.

### DETAILED DESCRIPTION OF THE INVENTION

In the following same or similar functioning elements are indicated with the same reference numerals.

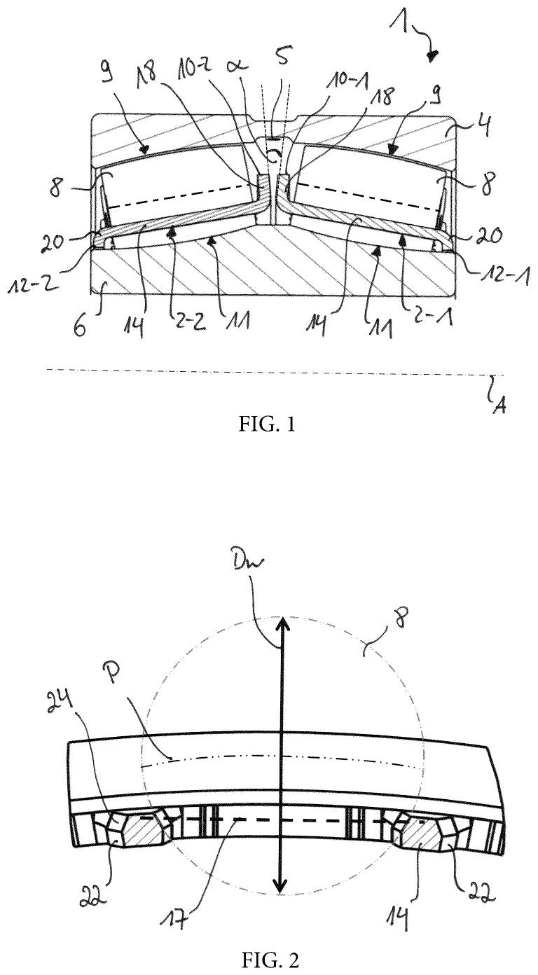

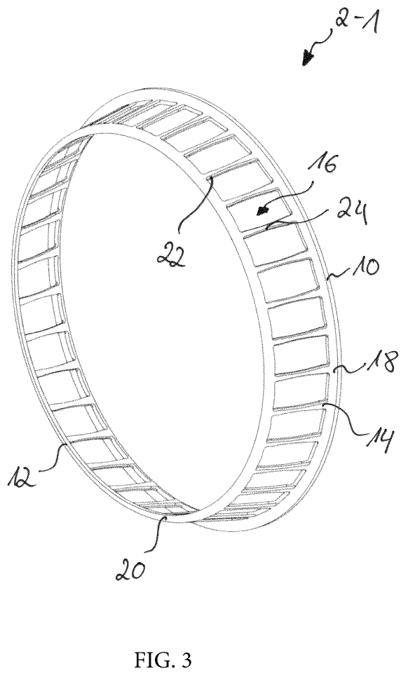

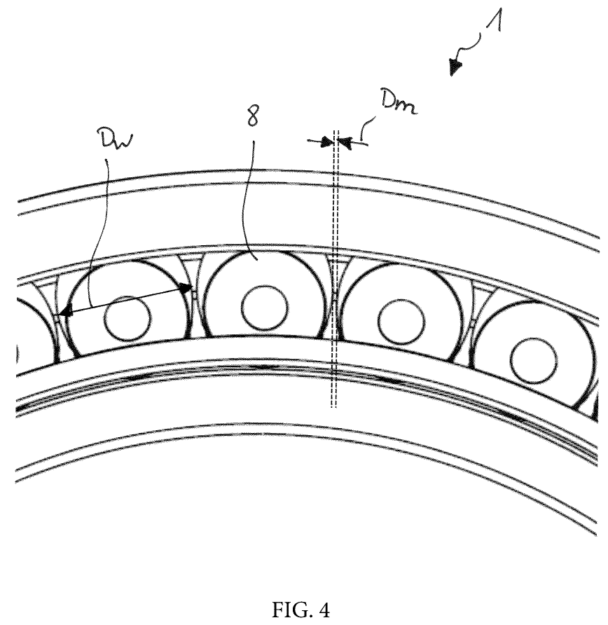

FIGS. 1 to 4 show a spherical roller bearing 1 for supporting a wind turbine main shaft as well as a first cage 2-1 of the spherical roller bearing 1.

The spherical roller bearing 1 comprises an outer ring 4, an inner ring 6 and two sets of spherical rollers 8 which roll along raceways 9 formed on the outer ring 4 and on raceways 11 formed on the inner ring 6. The outer ring 4 includes an opening 5 through which lubricant can be provided to the spherical roller bearing 1. In particular, the outer ring 4 may be stationary while the inner ring 6 may rotate around a rotation axis A. Furthermore, the inner ring 6 may be configured to be mounted on a main shaft of a wind turbine.

The inner ring 6 may be formed with or without flanges on an axial inner side and/or an axial outer side. The spherical roller bearing 1 shown in FIG. 1 is formed without flanges on both the axial inner side and the axial outer side of the inner ring 6.

Furthermore, the spherical roller bearing 1 comprises a first cage 2-1 configured to retain the first set of spherical rollers 8 and a second cage 2-2 configured to retain the second set of spherical rollers 8. The first and second cages 2-1, 2-2 are identical in shape or identically formed. FIG. 2 shows the first cage 2-1 in detail.

In addition, both the first cage 2-1 and the second cage 2-2 are free of any means for retaining at least one spherical roller 8 in either the first cage 2-1 or the second cage 2-2 or in a pocket 16 of the first and/or second cages 2-1, 2-2. In other words, neither one of the first cage 2-1 and the second cage 2-2 includes any means for snapping the spherical rollers 8 into the cages 2-1, 2-2 or dimples formed on the axial end faces of the pockets 16 for engaging with recesses formed on end faces of the spherical rollers 8.

Furthermore, the first and second cage 2-1, 2-2 can be mounted or installed into the spherical roller bearing 1 without elastically and/or plastically deforming the first and second cage 2-1, 2-2 and/or without disassembling or cutting the first and second cages 2-1, 2-2.

Each cage 2-1, 2-2 comprises a first cage ring 10-1, 10-2 extending in a circumferential direction of the bearing, a second cage ring 12-1, 12-2 axially spaced from the first cage ring 10-1, 10-2 and connected to the first cage 10-1, 10-2 with a plurality of cage bars 14 thereby forming a plurality of closed pockets 16. Each pocket 16 is configured to receive one spherical roller 8. In particular, each cage 2-1, 2-2 may be integrally formed.

The first cage ring 10-1, 10-2 has a flange element 18 radially to the outside, and the second cage ring 12-1, 12-2 has a flange element 20 radially extending to the inside.

The free ends of the flange elements 18 of the first cage rings 10-1, 10-2 are inclined in direction towards the spherical roller 8 such that the free ends form an opening angle α, as shown in FIG. 1. Preferably the opening angle α is in the range between 2° and 40°.

Moreover, the cage bars 14 are at least partially arranged at a position that is offset to the radial inside of a pitch diameter P of the spherical roller bearing 1. Preferably, the position corresponds to 10% to 40% of the maximal diameter Dw of the spherical roller 8 used in the spherical roller bearing 1. In the depicted embodiment, the cage bar 14 is arranged such that a contact between the spherical roller 8 and the cage bar 14 is at a position that corresponds to about 30% of a maximal diameter Dw (as indicated by dashed line 17) of the spherical rollers 8. The maximal diameter Dw of the spherical rollers 8 is indicated in FIG. 4.

Arranging the cage bars 14 offset inwardly from the pitch diameter P may enable a decrease in a minimal distance Dm (FIG. 4) between the raceways of two adjacent rollers 8 such that it may be possible to increase the number of rollers used in a set of rollers 8. The minimal distance Dm is determined in a condition in which the spherical rollers 8 are equally spaced in the circumferential direction.

In particular, a ratio Dm/Dw of the minimal distance in the circumferential direction between the raceways of two adjacent spherical rollers 8 of the first and/or second set of spherical rollers to the maximal roller diameter Dw is equal to or below 0.11, preferably 0.09, and even more preferred 0.075, when the spherical rollers 8 of the respective set of rollers 8 are equally spaced in the circumferential direction.

Alternatively or additionally, the minimal distance Dm in the circumferential direction between the raceways of two adjacent spherical rollers of the first and/or second set of spherical rollers may be equal to or below a value obtained by the following equation:

$$Dm \leq 0.0064 mm \cdot {( ln ( P \cdot Dw + Dw ) )}^{3}$$

when the spherical rollers 8 of the respective set of rollers 8 are equally spaced in the circumferential direction, wherein P is the pitch diameter and Dw is the maximal roller diameter, and wherein the millimeter values of P and Dw are used as dimensionless variables.

The spherical roller bearing 1 is designed such that a shoulder clearance is larger than a radial cage clearance. For example, the shoulder clearance may be between 1 mm and 15 mm larger than the radial cage clearance, if the cage bore diameter up to 1200 mm. In case the cage bore diameter is larger than 1200 mm, the shoulder clearance may be between 1 mm and 20 mm larger than the radial cage clearance. This enables the cage 2 be designed to be predominantly roller guided.

Furthermore, each cage bar 14 of the cages 2-1, 2-2 of the spherical roller bearing 1 according to the first embodiment, is provided with at least one contact area 24 configured to contact the spherical roller 8, wherein the contact area 24 is positioned at a circumferential side face 22 of each cage bar 14.

The contact surface or area 24 is at least partially provided with a radius such that an osculation is formed between the cage bar 14 and the roller 8 along the roller axis. The osculation, which is the radius on cage bar 14 divided by a crowning radius of the roller, may be between 100% and 104%. Moreover, each cage bar 14 of the spherical roller bearing 1 according to the first embodiment has in the axial direction one contact area 24.

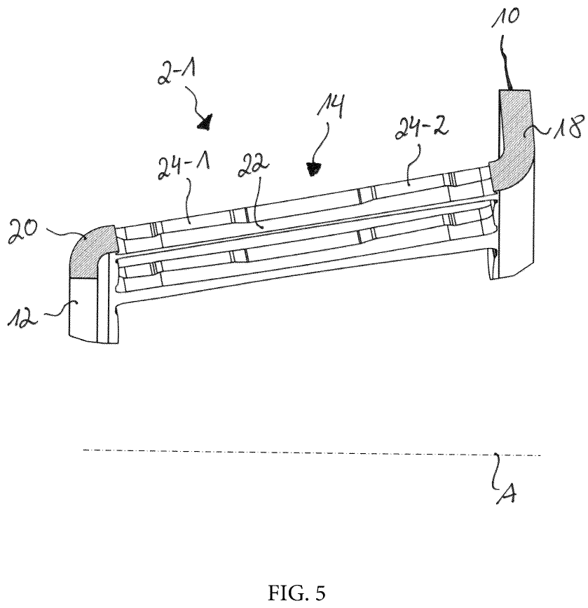

FIG. 5 shows a cross section of a cage 2 for a spherical roller bearing 1 according to a second embodiment. The cage 2 of the second embodiment differs from the cage 2 of the first embodiment in that a circumferential side face 22 of each cage bar 14 is provided in the axial direction with two contact areas 24-1, 24-2 configured to contact the roller 8.

Although FIG. 5 shows an embodiment having two contact areas 24-1, 24-2 it may also be possible to provide more than two contact areas.

In summary, providing two separate cages 2-1, 2-2 may have the advantage that lubricant flow to the inner ring 6 may be improved. In particular, a gap formed between the first cage rings 10-1, 10-2 of the first and second cage 2-1, 2-2 may act like a funnel that transports the lubricant to the inner ring 6 of the spherical roller bearing 1. Furthermore, having two separate cages 2-1, 2-2 enables the first row of spherical rollers 8 retained in the first cage 2-1 to have a different rotational speed than the second row of spherical rollers 8 retained by the second cage 2-2. This may reduce forces acting on the cages 2-1, 2-2 compared to a design in which only one cage is used.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### REFERENCE NUMERALS

1 spherical roller bearing
2-1 first cage
2-2 second cage
4 outer ring
5 opening
6 inner ring
8 spherical roller
9 outer raceway
10-1, 10-2 first cage ring
11 inner raceway
12-1, 12-2 second cage ring
14 cage bar
16 pocket
18 flange element
20 flange element
22 circumferential side face
24 contact area
α opening angle
A rotation axis

We claim:

1. A spherical roller bearing for supporting a main shaft of a wind turbine, the spherical roller bearing comprising:
an outer ring having two raceways;
an inner ring having two raceways and a diameter of at least 499 mm;
two sets of spherical rollers which each roll along the raceways of the outer and inner rings; and
first and second cages each configured to retain a separate one of the two sets of spherical rollers, each one of the first and second cages including a first cage ring extending in a circumferential direction of the spherical roller bearing, a second cage ring spaced axially from the first cage ring and connected to the first cage ring by a plurality of cage bars so as to form a plurality of closed pockets, each pocket being configured to receive one spherical roller of one set of spherical rollers.

2. The spherical roller bearing according to claim 1, wherein the inner ring is formed without a flange configured to retain and/or guide the spherical rollers and/or the spherical roller bearing is formed without a guide ring.

3. The spherical roller bearing according to claim 1, wherein a ratio Dm/Dw of a minimal distance (Dm) in the circumferential direction between the raceways of two adjacent spherical rollers of at least one of the two sets of spherical rollers to a maximal roller diameter (Dw) is no greater than 0.11 when the spherical rollers of the at least one set of rollers are equally spaced in the circumferential direction.

4. The spherical roller bearing according to claim 3, wherein the ratio Dm/Dw is no greater than 0.075.

5. The spherical roller bearing according to claim 3, wherein a minimal distance Dm in the circumferential direction between the raceways of two adjacent spherical rollers of at least one set of spherical rollers is equal to or below a value obtained by the following equation:
$$Dm \leq 0.0064 mm \cdot {( ln ( P \cdot Dw + Dw ) )}^{3} ,$$
when the spherical rollers of the at least one set of spherical rollers are equally spaced in the circumferential direction, wherein P is the pitch diameter and Dw is the maximum roller diameter, and wherein the millimeter values of P and Dw are used as dimensionless variables.

6. The spherical roller bearing according to claim 1, wherein the first cage ring of each one of the first and second cages is arranged on an axially inner side of the spherical roller bearing such that a gap is formed at least partially between the first cage ring of the first cage and the first cage ring of the second cage.

7. The spherical roller bearing according to claim 6, wherein a size of the gap in the axial direction is at least 0.5 mm.

8. The spherical roller bearing according to claim 7, wherein the size of the gap in the axial direction is at least 1.0 mm.

9. The spherical roller bearing according to claim 1, wherein:
the first cage ring of each one of the first and second cages and/or at least one of the second cage rings includes a flange element that extends radially inwardly or radially outwardly; or
the first cage ring of each one of the first and second cages and at least one of the second cage rings includes a radially extending flange element, wherein both flange elements extend radially inwardly or both extend flange elements extend radially outwardly; or
the first cage ring of each one of the first and second cages and at least one of the second cage rings includes a radially extending flange element, wherein one flange element extends radially inwardly and the other flange element extends radially outwardly.

10. The spherical roller bearing according to claim 9, wherein a free end of the flange element of the first cage ring of each one of the first and second cages is inclined in a direction toward the spherical roller.

11. The spherical roller bearing according to claim 10, wherein the free ends of the flange element of the first cage ring of each one of the first and second cages have an opening angle with a value within a range between 2° and 40°

12. The spherical roller bearing according to claim 1, wherein the first cage and/or the second cage is roller guided.

13. The spherical roller bearing according to claim 1, wherein a shoulder clearance is larger than a radial cage clearance.

14. The spherical roller bearing according to claim 1, wherein a circumferential side face of each one of the cage bars is provided in the axial direction with one contact area or two contact areas each configured to contact the spherical roller.

15. The spherical roller bearing according to claim 1, wherein at least one of the first and second cages is made from sheet metal.

16. The spherical roller bearing according to claim 1, wherein:
at least one of the first and second cages is formed without any means for retaining at least one spherical roller within the at least one cage and/or within the pockets of the at least one cage; and/or
at least one of the first and second cages and/or the spherical rollers are mountable into the spherical roller bearing without elastically and/or plastically deforming the at least one cage and/or without disassembling the at least one cage.

17. A bearing arrangement for a wind turbine main shaft, wherein the bearing arrangement includes at least one spherical roller bearing according to claim 1.
